(19) United States
(12) Patent Application Publication
(10) Pub. No.: US 2024/0124358 A1
(43) Pub. Date: Apr. 18, 2024

(54) Gypsum Panel Containing A Carbon Sequestration Additive

(71) Applicant: Gold Bond Building Products, LLC, Charlotte, NC (US)

(72) Inventors: Eli Stav, Charlotte, NC (US); Craig Robertson, Charlotte, NC (US); Joseph J. Bailey, Charlotte, NC (US); R. G. Iyer, Charlotte, NC (US); Rick Atkisson, Shelby, NC (US); Bradley J. Busche, Shelby, NC (US)

(21) Appl. No.: 18/486,304

(22) Filed: Oct. 13, 2023

Related U.S. Application Data
(60) Provisional application No. 63/415,855, filed on Oct. 13, 2022.

(51) Int. Cl. C04B 28/14; C04B 11/26; C04B 14/06

(52) U.S. Cl. CPC C04B 28/14; C04B 11/26; C04B 14/06; C04B 2111/00017

(57) ABSTRACT

The present invention is directed to a gypsum panel and a method of making such gypsum panel. For instance, in one embodiment, the gypsum panel comprises a gypsum core and a first facing material and a second facing material sandwiching the gypsum core, wherein the gypsum core includes gypsum and one or more carbon sequestration additives. The methods of the present invention are directed to making the aforementioned gypsum panels by providing the first facing material, providing a gypsum slurry comprising gypsum, water, and one or more carbon sequestration additives onto the first facing material, and providing a second facing material on the gypsum slurry.

### RELATED APPLICATIONS

The present application is based on and claims priority to U.S. Provisional Patent Application Ser. No. 63/415,855, having a filing date of Oct. 13, 2022, which is incorporated herein by reference in its entirety.

### BACKGROUND OF THE INVENTION

Gypsum panels are commonly employed in drywall construction of interior walls and ceilings and also have other applications. Generally, these gypsum panels are formed from a gypsum slurry including a mixture of calcined gypsum, water, and other conventional additives. The mixture is cast and allowed to set by reaction of the calcined gypsum with the water. During the production process, a variety of additives can be incorporated into the gypsum panel to enhance the physical and mechanical properties of the gypsum panel.

In the present day, carbon emissions have become a growing concern. Notably, a substantial number of corporate sustainability objectives and national environmental initiatives have focused on minimizing the negative effects of carbon emissions. Indeed, most industries have responded to this environmental concern by reducing the amount of carbon emissions formed from producing their products or stemming from the operation of their products. In particular, gypsum panel manufacturers have attempted to reduce overall carbon emissions through a variety of methods. However, these various methods have proven to be cost-intensive and of limited efficacy.

As a result, there is a need to provide an improved gypsum panel that provides for enhanced carbon sequestration.

### SUMMARY OF THE INVENTION

In accordance with one embodiment of the present invention, a gypsum panel is disclosed. The gypsum panel comprises a gypsum core and a first facing material and a second facing material sandwiching the gypsum core, wherein the gypsum core comprises gypsum and one or more carbon sequestration additives comprising a silicate, one or more metal hydroxides, or a combination thereof.

In accordance with another embodiment of the present invention, a method of making a gypsum panel is disclosed. The method comprises: providing a first facing material; depositing a gypsum slurry comprising stucco, water, and one or more carbon sequestration additives onto the first facing material, wherein the one or more carbon sequestration additives comprise a silicate, one or more metal hydroxides, or a combination thereof; providing a second facing material on the gypsum slurry; and allowing the stucco to convert to calcium sulfate dihydrate.

In accordance with one embodiment of the present invention, a gypsum panel is disclosed. The gypsum panel comprises a gypsum core and a first facing material and a second facing material sandwiching the gypsum core, wherein the gypsum core comprises gypsum and one or more carbon sequestration additives comprising activated coke, a volcanic glass, a volcanic rock, pyrolyzed biomass, an attapulgite clay, an aluminosilicate, a metal organic framework, a coordination polymer, an amine, an amide, a germanate, a stannate, an aluminophosphate, a covalent organic framework, an ionic liquid, an ionic exchange resin, a mesoporous silica, a functionalized mesoporous silica, a functionalized organic resin, or a combination thereof.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a gypsum panel and a method of making such gypsum panel. In particular, the gypsum panel can include a gypsum core including one or more carbon sequestration additives as defined herein. In this regard, the gypsum core can include gypsum (i.e., calcium sulfate dihydrate), one or more carbon sequestration additives, and may include other optional additives. The present inventors have discovered that the gypsum panel disclosed herein can have various benefits due to the use of one or more carbon sequestration additives. For instance, the present inventors have discovered that the mechanical properties and characteristics of the panel may be improved. For instance, the gypsum panel disclosed herein may sequester carbon dioxide from the atmosphere for an extended period of time, such as one or more years.

It should be understood that throughout the entirety of this specification, each numerical value (e.g., weight percentage, concentration) disclosed should be read as modified by the term “about” (unless already expressly so modified) and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value.

In general, the gypsum core may comprise calcium sulfate dihydrate. The gypsum may be from a natural source or a synthetic source and is thus not necessarily limited by the present invention. In general, the gypsum, in particular the calcium sulfate dihydrate, is present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum is present in an amount of 100 wt. % or less, such as 99 wt. % or less, such as 98 wt. % or less, such as 95 wt. % or less, such as 90 wt. % or less based on the weight of the solids in the gypsum slurry. In one embodiment, the aforementioned weight percentages are based on the weight of the gypsum core. In another embodiment, the aforementioned weight percentages are based on the weight of the gypsum panel.

The one or more carbon sequestration additives of the present disclosure may sequester carbon dioxide from the atmosphere through chemical and/or physical sequestering. For instance, the one or more carbon sequestration additives may form a chemical bond with carbon dioxide such that carbon dioxide is sequestered through chemical sequestering. Further, for instance, carbon dioxide may be physically adsorbed by the one or more carbon sequestration additives such that carbon dioxide is sequestered through physical sequestering.

Generally, the weight ratio of the one or more carbon sequestration additives present in the gypsum panel to the amount of carbon dioxide that can be sequestered by the one or more carbon sequestration additives may be from about 100:1 to about 1:1, including all ratios therebetween. For instance, when the weight ratio of the one or more carbon sequestration additives present in the gypsum panel to the amount of carbon dioxide sequestered by the one or more carbon sequestration additives is about 1:1, about one kilogram of the one or more carbon sequestration additives present in the gypsum panel may sequester about one kilogram of carbon dioxide from the atmosphere or air. Generally, the weight ratio of the one or more carbon sequestration additives present in the gypsum panel to the amount of carbon dioxide sequestered by the one or more carbon sequestration additives may be about 100:1 or less, such as about 90:1 or less, such as about 80:1 or less, such as about 70:1 or less, such as about 60:1 or less, such as about 50:1 or less, such as about 40:1 or less, such as about 30:1 or less, such as about 20:1 or less, such as about 10:1 or less. Generally, the weight ratio of the one or more carbon sequestration additives present in the gypsum panel to the amount of carbon dioxide sequestered by the one or more carbon sequestration additives may be about 1:1 or more, such as about 10:1 or more, such as about 20:1 or more, such as about 30:1 or more, such as about 40:1 or more, such as about 50:1 or more, such as about 60:1 or more, such as about 70:1 or more, such as about 80:1 or more, such as about 90:1 or more.

In one embodiment, a gypsum panel comprising one or more carbon sequestration additives may have a sequestration efficiency of about 1% to about 100%. As used herein, “sequestration efficiency” refers to the weight of carbon dioxide that can be sequestered by the one or more carbon sequestration additives present in the gypsum panel over the weight of the one or more carbon sequestration additives present in the gypsum panel. For instance, a sequestration efficiency of 10% would convey that 1/10 of a kilogram of carbon dioxide is sequestered per kilogram of the one or more carbon sequestration additives present in the gypsum panel. Further, for instance, a sequestration efficiency of 100% would convey that one kilogram of carbon dioxide is sequestered for every kilogram of the one or more carbon sequestration additives present in the gypsum panel. In general, the sequestration efficiency of the gypsum panel may be about 1% or more, such as about 5% or more, such as about 10% or more, such as about 20% or more, such as about 30% or more, such as about 40% or more, such as about 50% or more, such as about 60% or more, such as about 70% or more, such as about 80% or more, such as about 90% or more. The sequestration efficiency of the gypsum panel may be about 100% or less, such as about 90% or less, such as about 80% or less, such as about 70% or less, such as about 60% or less, such as about 50% or less, such as about 40% or less, such as about 30% or less, such as about 20% or less, such as about 10% or less, such as about 5% or less.

When containing one or more carbon sequestration additives, the gypsum panel of the present disclosure may actively sequester carbon for a selectively chosen period of time. In one aspect, the gypsum panel of the present disclosure may actively sequester carbon dioxide for a period of 12 hours to a period of 200 years, including all increments of twenty-four hours therebetween. For instance, the gypsum panel may sequester carbon dioxide for a period of 12 hours or more, such as a period of 1 day or more, such as a period of 1 week or more, such as a period of 1 month or more, such as a period of 6 months or more, such as a period of 1 year or more, such as a period of 2.5 years or more, such as a period of 5 years or more, such as a period of 10 years or more, such as a period of 20 years or more, such as a period of 40 years or more, such as a period of 80 years or more, such as a period of 100 years or more. Generally, the gypsum panel may sequester carbon dioxide for a period of 200 years or less, such as a period of 150 years or less, such as a period of 100 years or less, such as a period of 80 years or less, such as a period of 40 years or less, such as a period of 20 years or less, such as a period of 10 years or less, such as a period of 5 years or less, such as a period of 2.5 years or less, such as a period of 1 year or less, such as a period of 6 months or less, such as a period of 1 month or less, such as a period of 1 day or less.

Generally, the one or more carbon sequestration additives can include any additive that may sequester carbon. For instance, the one or more carbon sequestration additives may include any porous material that sequesters carbon dioxide. Any respective component (e.g., gypsum core, gypsum core layer, facing material) of the gypsum panel may comprise one or more carbon sequestration additives. In one aspect, the one or more carbon sequestration additives may include a silicate (e.g., a silicate mineral), one or more metal hydroxides, or a combination thereof.

In one embodiment, the one or more carbon sequestration additives may comprise a silicate mineral. In another embodiment, the gypsum panel may include more than one silicate mineral, such as two silicate minerals or three silicate minerals. The silicate mineral may be a solid solution series mineral. Generally, the silicate mineral may comprise any and all ratios of compositions comprising the compositional range between two or more endmembers of a solid solution series.

In one embodiment, olivine, more particularly olivine sand, may be used as a carbon sequestration additive. As used herein, the term olivine or olivine sand can refer to a solid solution series mineral containing a variety of endmembers. For instance, in one solid solution series of olivine, the series has a magnesium endmember and an iron endmember. The magnesium endmember of the olivine solid solution series has the chemical formula Mg₂SiO₄. This magnesium endmember may be referred to as forsterite. The iron endmember of the olivine solid solution series has the chemical formula Fe₂SiO₄. This iron endmember may be referred to as fayalite. Other solid solution series of olivine may include a manganese endmember having the chemical formula Mn₂SiO₄. This manganese end member may be referred to as tephroite.

As indicated herein, the solid solution series may comprise any and all ratios of compositions comprising the compositional range between two or more endmembers. For instance, an intermediate composition, as opposed to an endmember, of olivine may be used as a carbon sequestration additive.

Generally, the chemical formula for such an intermediate composition of the forsterite and fayalite olivine solid solution series is (Mg, Fe)₂SiO₄. In an alternative embodiment, the chemical formula for an intermediate composition may also include manganese and/or calcium. When calcium is present in olivine, the chemical formula may be expressed as Ca₂SiO₄, which may be referred to as larnite, may be expressed as CaFeSiO₄, which may be referred to as kirschsteinite, may be expressed as CaMgSiO₄, which may be referred to as monticellite, or more generally may be expressed as any chemical formula indicative of an intermediate composition of olivine containing calcium.

As previously disclosed, the one or more carbon sequestration additives may comprise olivine sand. The olivine sand of the present disclosure may comprise one or more intermediate compositions and/or one or more endmembers from an olivine solid solution series. For instance, the olivine sand may comprise one or more intermediate compositions and endmembers of the forsterite and fayalite olivine solid solution series.

In one embodiment, the silicate mineral of the present disclosure may be a nesosilicate. For instance, the nesosilicate may be olivine. In another embodiment, the silicate mineral may be any one of a sorosilicate, cyclosilicate, inosilicate (single chain), inosilicate (double chain), phyllosilicate, or tectosilicate. For instance, the silicate mineral may be chosen from silicate minerals such as serpentine, pyroxene, feldspar, mica, amphibole, pyroxene, epidote, talc, wollastonite, and vesuvianite. In one embodiment, the pyroxene mineral may be enstatite or ferrosilite.

The gypsum panel of the present disclosure may comprise a silicate mineral in various forms. For instance, as previously indicated herein, the silicate mineral may be olivine sand derived from olivine. Further, for instance, the silicate mineral may be processed such that the silicate mineral is formed into granulated particles. In one embodiment, olivine may be processed into granulated particles to form olivine sand. Generally, the olivine sand may have coarse granulated particles or fine granulated particles. The silicate mineral granulated particles may be processed such that the average grain size of the particles is selectively chosen to enhance the carbon sequestration properties of the gypsum panel. For instance, the silicate mineral granulated particles may be sized such that the amount of carbon sequestered by the granulated particles is enhanced. In this respect, a decrease in the average grain size of the silicate mineral granulated particles may increase the amount of carbon sequestered by the granulated particles in a gypsum panel. Notably, a decrease in the average grain size of the silicate mineral granulated particles may increase the surface area of the silicate mineral granulated particles in the gypsum panel. Additionally, the silicate mineral granulated particles may be sized such that the particles sequester carbon dioxide for a specific period of time. In this respect, as the average grain size of the silicate mineral granulated particles increases, the amount of carbon dioxide sequestered per period of time may decrease, which may extend the sequestering life of the gypsum panel.

In another embodiment, the granulated particles may be selectively chosen such that the average grain size of the granulated particles is partially determined by the temperature range to which the gypsum panel is subjected. For instance, the average grain size of the granulated particles may be partially determined by considering the reaction rate of a silicate mineral with carbon dioxide at room temperature, such as a temperature of about 20° C. to about 25° C. In this respect, the average grain size of the granulated particles may be selectively chosen to allow the gypsum panel to sequester carbon at a specified temperature range for a determined period of time. Generally, the gypsum panel may be subjected to a temperature range of about 0° C. to about 40° C., such as about 0° C. or more, such as about 10° C. or more, such as about 20° C. or more, such as about 30° C. or more. The temperature the gypsum panel is subjected to may be about 40° C. or less, such as about 30° C. or less, such as about 20° C. or less, such as about 10° C. or less.

Generally, the silicate (e.g., silicate mineral) may have an average grain size from about 0.2 microns to about 3000 microns. For instance, the silicate mineral (e.g., olivine sand) may have an average grain size from about 0.2 microns to about 3000 microns, such as about 0.2 microns or more, such as about 0.5 microns or more, such as about 0.7 microns or more, such as about 1 micron or more, such as about 5 microns or more, such as about 10 microns or more, such as about 15 microns or more, such as about 20 microns or more, such as about 25 microns or more, such as about 50 microns or more, such as about 100 microns or more, such as about 500 microns or more, such as about 1000 microns or more, such as about 2000 microns or more. Generally, the silicate mineral has an average grain size of about 3000 microns or less, such as about 2000 microns or less, such as about 1000 microns or less, such as about 500 microns or less, such as about 100 microns or less, such as about 50 microns or less, such as about 25 microns or less, such as about 20 microns or less, such as about 15 microns or less, such as about 10 microns or less, such as about 5 microns or less, such as about 1 micron or less, such as about 0.7 microns or less, such as about 0.5 microns or less.

As indicated herein, in one embodiment, the gypsum panel may comprise olivine sand. The olivine sand may have a bulk density and/or specific density from about 1200 kg/m³ to about 4000 kg/m³, such as about 1200 kg/m³ or more, such as about 1300 kg/m³ or more, such as about 1400 kg/m³ or more, such as about 1500 kg/m³ or more, such as about 1600 kg/m³ or more, such as about 1700 kg/m³ or more, such as about 1800 kg/m³ or more, such as about 1900 kg/m³ or more, such as about 2000 kg/m³ or more, such as about 2500 kg/m³ or more, such as about 3000 kg/m³ or more, such as about 3500 kg/m³ or more. Generally, the bulk density and/or specific density of the olivine sand is about 4000 kg/m³ or less, such as about 3500 kg/m³ or less, such as about 3000 kg/m³ or less, such as about 2500 kg/m³ or less, such as about 2000 kg/m³ or less, such as about 1900 kg/m³ or less, such as about 1800 kg/m³ or less, such as about 1700 kg/m³ or less, such as about 1600 kg/m³ or less, such as about 1500 kg/m³ or less, such as about 1400 kg/m³ or less, such as about 1300 kg/m³ or less.

In general, the silicate mineral may react with carbon dioxide present in the atmosphere or air. In one embodiment, the silicate mineral may react with carbon dioxide in an exothermic reaction. In one aspect, the reaction of the silicate mineral with carbon dioxide may occur naturally, such as under atmospheric conditions. In this respect, no additional energy input may be required for the silicate mineral present in the gypsum panel to sequester carbon dioxide.

In one aspect, the inclusion of a silicate mineral in a gypsum panel formed in accordance with the present disclosure may be particularly applicable in humid conditions. For instance, as the humidity in the air increases, the reaction rate of the silicate mineral with carbon dioxide may also increase.

As previously disclosed, in one embodiment, one or more carbon sequestration additives may comprise one or more metal hydroxides. The one or more metal hydroxides may comprise one or more alkaline-earth metal hydroxides. For instance, the one or more metal hydroxides may comprise calcium hydroxide, magnesium hydroxide, or both.

Generally, the one or more carbon sequestration additives may comprise a carbon sequestration additive comprising one or more metal hydroxides. For instance, the one or more carbon sequestration additives may comprise slaked lime and/or hydrated dolomitic lime. Slaked lime is generally formed by the heating of limestone to release carbon dioxide, which is then followed by slaking of the decarbonated lime in water to form a composition comprising calcium hydroxide. The composition (i.e., calcium hydroxide) may be referred to as slaked lime. Hydrated dolomitic lime is formed by the heating of dolomite to release carbon dioxide, which is then followed by slaking of the decarbonated dolomitic lime in water to form a composition comprising calcium hydroxide and magnesium hydroxide. The composition comprising calcium hydroxide and magnesium hydroxide may be referred to as hydrated dolomitic lime. As evidenced by the two metal hydroxide components, calcium hydroxide and magnesium hydroxide, at least one of the one or more carbon sequestration additives, such as hydrated dolomitic lime, may comprise two metal hydroxides.

The gypsum panel of the present disclosure may comprise one or more metal hydroxides in various forms. For instance, the one or more metal hydroxides may be processed such that the metal hydroxides are formed into granulated particles. In one embodiment, the slaked lime or hydrated dolomitic lime may be processed into granulated particles. The metal hydroxide granulated particles may be processed such that the average grain size of the particles is selectively chosen to enhance the carbon sequestration properties of the granulated particles. For instance, the metal hydroxide granulated particles may be sized such that the amount of carbon sequestered by the particles is enhanced. In this respect, a decrease in the average grain size of the metal hydroxide granulated particles may increase the amount of carbon sequestered by the metal hydroxide granulated particles. Notably, a decrease in the average grain size of the metal hydroxide granulated particles may increase the surface area of the metal hydroxide granulated particles.

As previously disclosed herein, the amount of the one or more metal hydroxides present in the gypsum panel may enhance the carbon sequestration properties of the gypsum panel. For instance, an increase in the amount of the one or more metal hydroxides (i.e., slaked lime or hydrated dolomitic lime) formed from the hydration of the decarbonated lime or decarbonated dolomitic lime may increase the amount of carbon dioxide the gypsum panel can sequester. Further, for instance, the amount of the one or more metal hydroxides formed from the hydration of the decarbonated lime or decarbonated dolomitic lime may be selectively chosen such that a certain amount of unreacted decarbonated lime or decarbonated dolomitic lime remains in the gypsum panel at the end of the gypsum panel formation process. This unreacted decarbonated lime or decarbonated dolomitic lime of the gypsum panel may react with water in the atmosphere over a period of time to form slaked lime or hydrated dolomitic lime. In this respect, the carbon sequestration properties of the gypsum panel may be continuously enhanced over the life of the gypsum panel. For instance, any respective layer of the gypsum panel may continuously form carbon dioxide binding sites over the life of the gypsum panel by way of water, such as water in the atmosphere (moisture), reacting with the decarbonated lime or decarbonated dolomitic lime to form slaked lime or hydrated dolomitic lime.

As indicated herein, in one embodiment, the gypsum panel may comprise slaked lime. The slaked lime can have a bulk density from about 200 kg/m³ to about 1200 kg/m³, such as about 200 kg/m³ or more, such as about 300 kg/m³ or more, such as about 400 kg/m³ or more, such as about 500 kg/m³ or more, such as about 600 kg/m³ or more, such as about 700 kg/m³ or more, such as about 800 kg/m³ or more, such as about 900 kg/m³ or more, such as about 1000 kg/m³ or more, such as about 1100 kg/m³ or more. Generally, the bulk density of the slaked lime is about 1200 kg/m³ or less, such as about 1100 kg/m³ or less, such as about 1000 kg/m³ or less, such as about 900 kg/m³ or less, such as about 800 kg/m³ or less, such as about 700 kg/m³ or less, such as about 600 kg/m³ or less, such as about 500 kg/m³ or less, such as about 400 kg/m³ or less, such as about 300 kg/m³ or less.

As indicated herein, in one embodiment, the gypsum panel may comprise hydrated dolomitic lime. The hydrated dolomitic lime can have a bulk density from about 200 kg/m³ to about 1200 kg/m³, such as about 200 kg/m³ or more, such as about 300 kg/m³ or more, such as about 400 kg/m³ or more, such as about 500 kg/m³ or more, such as about 600 kg/m³ or more, such as about 700 kg/m³ or more, such as about 800 kg/m³ or more, such as about 900 kg/m³ or more, such as about 1000 kg/m³ or more, such as about 1100 kg/m³ or more. Generally, the bulk density of the hydrated dolomitic lime is about 1200 kg/m³ or less, such as about 1100 kg/m³ or less, such as about 1000 kg/m³ or less, such as about 900 kg/m³ or less, such as about 800 kg/m³ or less, such as about 700 kg/m³ or less, such as about 600 kg/m³ or less, such as about 500 kg/m³ or less, such as about 400 kg/m³ or less, such as about 300 kg/m³ or less.

In one embodiment, the gypsum panel may be processed such that any respective gypsum core layer may have an average void size of about 90 microns to about 2000 microns, such as about 90 microns or more, such as about 100 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more, such as about 600 microns or more, such as about 700 microns or more, such as about 800 microns or more. Generally, the average void size may be about 3000 microns or less, such as about 1500 microns or less, such as about 1300 microns or less, such as about 1100 microns or less, such as about 1000 microns or less, such as about 900 microns or less, such as about 800 microns or less, such as about 700 microns or less, such as about 600 microns or less, such as about 500 microns or less, such as about 400 microns or less, such as about 300 microns or less, such as about 200 microns or less, such as about 100 microns or less. In one embodiment, such core voids may reference any air voids due to voids generated from the use of a soap/foam. Furthermore, while the aforementioned references an average void size, it should be understood that in another embodiment, such size may also refer to a median void size.

The average void size of the gypsum panel, such as of a respective gypsum core layer, may affect the carbon sequestration properties of the gypsum panel, such as air diffusivity. For instance, larger void sizes may enhance the carbon sequestration properties of the gypsum panel. In this respect, larger void sizes may result in an increased volume of air passing through the gypsum panel. The increased volume of air passing through the gypsum panel may result in the one or more carbon sequestration additives present in the gypsum panel more regularly coming into contact with carbon dioxide, such increased contact decreasing the period of time the one or more carbon sequestration additives of the gypsum panel are sequestering carbon dioxide from the atmosphere. On the other hand, smaller void sizes may enhance the carbon sequestration properties of the gypsum panel. In this respect, the smaller void sizes may result in a decreased volume of air passing through the gypsum panel. Such a decrease in the volume of air passing through the gypsum panel may increase the period of time the one or more carbon sequestration additives sequester carbon dioxide from the atmosphere.

It should be noted that all carbon sequestration additives previously disclosed herein comprise a non-limiting list of the one or more carbon sequestration additives that may be included in the gypsum panel of the present disclosure. For instance, the one or more carbon sequestration additives may include industrial residues such as slag or fly ash. Additionally, for instance, the one or more carbon sequestration additives may generally include mesoporous materials or microporous materials. Further, for instance, the one or more carbon sequestration additives may include activated coke, volcanic glass (e.g., perlite), volcanic rock (e.g., pumice), a pyrolyzed biomass (e.g., biochar, charcoal), an attapulgite clay, an aluminosilicate (e.g., zeolite), a metal organic framework, a coordination polymer, an amine (e.g., ethanolamine, ethylenediaminetetraacetic acid), an amide, a germanate, a stannate, an aluminophosphate, a covalent organic framework, an ionic liquid, an ionic exchange resin (e.g., an amine functionalized ionic exchange resin, an amide functionalized ionic exchange resin), a mesoporous silica (e.g., MCM-41, SBA-15), a functionalized mesoporous silica, a functionalized organic resin, or a combination thereof. It should be understood that the one or more carbon sequestration additives included in the gypsum panel may include one or more of any of the carbon sequestration additives disclosed herein.

In one aspect, the one or more carbon sequestration additives may comprise an aluminosilicate. For instance, the one or more carbon sequestration additives may comprise zeolite, andalusite, kyanite, sillimanite, or a combination thereof. In one aspect, the zeolite may be a natural zeolite, a modified zeolite, a zeotype, or a combination thereof. For instance, the zeolite may be a microporous zeolite or a mesoporous zeolite.

In another aspect, the one or more carbon sequestration additives may comprise an amine. For instance, the one or more carbon sequestration additives may comprise a primary amine, a secondary amine, a tertiary amine, a cyclic amine, or a combination thereof. Further, for instance, the one or more carbon sequestration additives may comprise polymeric amines, aminosilicones, or a combination thereof.

In a further aspect, the one or more carbon sequestration additives may comprise an amide. For instance, the one or more carbon sequestration additives may comprise a primary amide, a secondary amide, a tertiary amide, a cyclic amide, or a combination thereof.

In yet another aspect, the one or more carbon sequestration additives may comprise a germanate, a stannate, an aluminophosphate, a covalent organic framework, or a combination thereof.

In yet another further aspect, the one or more carbon sequestration additives may comprise a functionalized mesoporous silica. For instance, a mesoporous silica may be functionalized with one or more amine groups. For instance, a mesoporous silica may be functionalized with polyethyleneimine (PEI).

In yet an additional aspect, the one or more carbon sequestration additives may comprise a functionalized organic resin. For instance, an organic resin may be functionalized with one or more amine groups. In this respect, an organic resin may be functionalized with polyethyleneimine.

The one or more carbon sequestration additives may sequester carbon dioxide via one or more mechanisms. For instance, the one or more carbon sequestration additives may sequester carbon dioxide via chelation, a chemical change, adsorption, or a combination thereof. For instance, pyrolyzed biomass, an amine, or an amide may sequester carbon dioxide via chelation. Further, for instance, a silicate, one or more metal hydroxides, activated coke, a volcanic glass, a volcanic rock, a coordination polymer, a germanate, a stannate, a covalent organic framework, an ionic liquid, an ionic exchange resin, a functionalized mesoporous silica, a functionalized organic resin, or a combination thereof may sequester carbon dioxide via a chemical change. Additionally, for instance, an aluminosilicate, an attapulgite clay, a metal organic framework, an aluminophosphate, a mesoporous silica, or a combination thereof may sequester carbon dioxide via adsorption.

Generally, one or more carbon sequestration additives may be present in any layer of the disclosed gypsum panel. For instance, one or more carbon sequestration additives may be present in one or more of the facing materials of the gypsum panel. Additionally or alternatively, for instance, one or more carbon sequestration additives may be present in the gypsum slurry or the gypsum core of the gypsum panel. Further, for instance, one or more carbon sequestration additives may be present in one or more gypsum core layers (e.g., first gypsum core layer, second gypsum core layer, third gypsum core layer) of the gypsum panel.

The one or more carbon sequestration additives may be present in the gypsum panel in an amount of 0.001 lbs/MSF to about 500 lbs/MSF, including all increments of 0.001 lbs/MSF therebetween. For instance, the one or more carbon sequestration additives may be present in the gypsum panel in an amount of 0.001 lbs/MSF or more, such as 0.01 lbs/MSF or more, such as 0.05 lbs/MSF or more, such as 0.1 lb/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 10 lbs/MSF or more, such as 50 lbs/MSF or more, such as 100 lbs/MSF or more, such as 125 lbs/MSF or more, such as 200 lbs/MSF or more, such as 300 lbs/MSF or more, such as 400 lbs/MSF or more. Generally, the one or more carbon sequestration additives may be present in the gypsum panel in an amount of 500 lbs/MSF or less, such as 400 lbs/MSF or less, such as 300 lbs/MSF or less, such as 200 lbs/MSF or less, such as 150 lbs/MSF or less, such as 125 lbs/MSF or less, such as 100 lbs/MSF or less, such as 50 lbs/MSF or less, such as 25 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

In general, one or more carbon sequestration additives may be present in the gypsum panel, including any component thereof, in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. Generally, one or more carbon sequestration additives may be present in the gypsum panel, including any component thereof, in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.30 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

In order to provide the desired effect, the one or more carbon sequestration additives may have a particular size. It should be noted that the respective average particle or grain sizes of the carbon sequestration additives previously disclosed herein are non-limiting (e.g., silicate). For instance, one or more carbon sequestration additives may have an average particle size of 3000 microns or less, such as 1000 microns or less, such as 400 microns or less, such as 300 microns or less, such as 200 microns or less, such as 150 microns or less, such as 100 microns or less, such as 75 microns or less, such as 50 microns or less, such as 40 microns or less, such as 25 microns or less, such as 15 microns or less, such as 10 microns or less, such as 5 microns or less, such as 1 micron or less, such as 900 nanometers or less, such as 800 nanometers or less, such as 600 nanometers or less, such as 500 nanometers or less, such as 300 nanometers or less, such as 200 nanometers or less, such as 100 nanometers or less, such as 50 nanometers or less, such as 25 nanometers or less, such as 10 nanometers or less. In general, the one or more carbon sequestration additives may have an average particle size of 1 nanometer or more, such as 5 nanometers or more, such as 10 nanometers or more, such as 20 nanometers or more, such as 30 nanometers or more, such as 40 nanometers or more, such as 50 nanometers or more, such as 100 nanometers or more, such as 250 nanometers or more, such as 500 nanometers or more, such as 750 nanometers or more, such as 1 micron or more, such as 5 microns or more, such as 10 microns or more, such as 20 microns or more, such as 50 microns or more, such as 100 microns or more, such as 200 microns or more, such as 300 microns or more, such as 400 microns or more, such as 1000 microns or more. Furthermore, in one aspect, the aforementioned values may refer to a median particle size of the one or more carbon sequestration additives.

In general, the composition of the gypsum core is not necessarily limited and may include any additives as known in the art. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants, fillers (e.g., glass spheres, glass fibers), natural and synthetic fibers (e.g. cellulosic fibers, microfibrillated fibers, nanocellulosic fibers, etc.), waxes (e.g., silicones, siloxanes, etc.), acids (e.g., boric acid), secondary phosphates (e.g., condensed phosphates or orthophosphates including trimetaphosphates, polyphosphates, and/or cyclophosphates, etc.), mixtures thereof, natural and synthetic polymers, starches, sound dampening polymers (e.g., viscoelastic polymers/glues, such as those including an acrylic/acrylate polymer, etc.; polymers with low glass transition temperature, etc.), etc., and mixtures thereof. In general, it should be understood that the types and amounts of such additives are not necessarily limited by the present invention.

Each additive of the gypsum core may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

As indicated herein, the gypsum core is sandwiched by facing materials. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material. In one aspect, the facing material and/or the coating applied thereto may be selectively chosen such that it enhances the carbon sequestration properties of the gypsum panel.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

The glass mat facing material in one embodiment may be coated. However, in one particular embodiment, the glass mat facing material may not have a coating, such as a coating that is applied to the surface of the mat.

In general, the present invention is also directed to a method of making a gypsum panel. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry. The first facing material, the gypsum core, and the second facing material may then be dried simultaneously. Next, the first facing material, the gypsum core, and the second facing material may be cut such that the first facing material, the gypsum core, and the second facing material form a gypsum panel.

In general, the composition of the gypsum slurry and gypsum core is not necessarily limited and may be any generally known in the art. Generally, in one embodiment, the gypsum core is made from a gypsum slurry including at least stucco and water. However, as indicated herein, at least one gypsum slurry includes one or more carbon sequestration additives. In this regard, the method may include a step of also combining one or more carbon sequestration additives with the stucco, water, and any optional additives as indicated herein.

In general, stucco may be referred to as calcined gypsum or calcium sulfate hemihydrate. The calcined gypsum may be from a natural source or a synthetic source and is thus not necessarily limited by the present invention. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be α-hemihydrate, β-hemihydrate, or a mixture thereof.

In addition to the stucco, the gypsum slurry may also contain other cementitious materials. These cementitious materials may include calcium sulfate anhydrite, land plaster, cement, fly ash, or any combinations thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

As indicated above, the gypsum slurry may also include water. Water may be employed for fluidity and also for rehydration of the gypsum to allow for setting. The amount of water utilized is not necessarily limited by the present invention.

The weight ratio of the water to the stucco may be 0.1 or more, such as 0.2 or more, such as 0.2 or more, such as 0.3 or more, such as 0.4 or more, such as 0.5 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses and other fibers (e.g. cellulosic fibers, microfibrillated fibers, nanocellulosic fibers, etc.), high molecular weight polymers, etc.), leveling agents, non-leveling agents, starches (such as pregelatinized starch, non-pregelatinized starch, and/or an acid modified starch), colorants, fire retardants or additives (e.g., silica, silicates, expandable materials such as vermiculite, perlite, etc.), water repellants, fillers (e.g., glass fibers), waxes (e.g., silicones, siloxanes, etc.), secondary phosphates (e.g., condensed phosphates or orthophosphates including trimetaphosphates, polyphosphates, and/or cyclophosphates, etc.), sound dampening polymers (e.g., viscoelastic polymers/glues, such as those including an acrylic/acrylate polymer, etc.; polymers with low glass transition temperature, etc.), mixtures thereof, natural and synthetic polymers, etc. In general, it should be understood that the types and amounts of such additives are not necessarily limited by the present invention.

Each additive of the gypsum slurry may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

The foaming agent may be one generally utilized in the art. For instance, the foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate. When a mixture is present, the alkyl ether sulfate may be present in an amount of 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 20 wt. % or more, based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

By utilizing a soap, a foaming agent, and/or foam as disclosed herein, the gypsum slurry may include bubbles or voids having a particular size. Such size may then contribute to the void structure in the gypsum panel and the resulting properties. In this regard, the gypsum slurry may have bubbles or voids having a median size of 90 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1000 microns or more. The gypsum slurry may have bubbles or voids having a median size of 1400 microns or less, such as 1300 microns or less, such as 1200 microns or less, such as 1100 microns or less, such as 1000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 100 microns or less. Furthermore, while the aforementioned references a median size, it should be understood that in another embodiment, such size may also refer to an average size.

In one aspect, the foam may be provided in an amount of 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

As indicated above, the additives may include at least one dispersant. The dispersant is not necessarily limited and may include any that can be utilized within the gypsum slurry. The dispersant may include carboxylates, sulfates, sulfonates, phosphates, mixtures thereof, etc. For instance, in one embodiment, the dispersant may include a sulfonate.

In another embodiment, the dispersant may include a carboxylate, such as a carboxylate ether and in particular a polycarboxylate ether or a carboxylate ester and in particular a polycarboxylate ester.

In a further embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof.

In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

The manner in which the components for the gypsum slurry are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer. In this regard, the manner in which the components are incorporated into the gypsum slurry is not necessarily limited by the present invention. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, a foaming agent and/or foam may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

Upon deposition of the gypsum slurry, the calcium sulfate hemihydrate reacts with the water to hydrate the calcium sulfate hemihydrate into a matrix of calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for drying of the gypsum slurry, in particular drying any free water instead of combined water of the gypsum slurry. Such drying may occur prior to the removal of any free moisture or water in a heating or drying device after a cutting step. Thereafter, the method may also comprise a step of cutting a continuous gypsum sheet into a gypsum panel. Then, after the cutting step, the method may comprise a step of supplying the gypsum panel to a heating or drying device. For instance, such a heating or drying device may be a kiln and may allow for removal of any free water. The temperature and time required for drying in such heating device are not necessarily limited by the present invention.

In one embodiment, the gypsum core may include a first gypsum core layer and a second gypsum core layer. The first gypsum core layer may be between the first facing material (i.e., front of the panel) and the second gypsum core layer. In addition, the first gypsum core layer may have a density greater than the second gypsum core layer. Accordingly, the first gypsum core layer may be formed using a gypsum slurry without the use of a foaming agent and/or foam or with a reduced amount of a foaming agent and/or foam, which may be utilized in forming the second gypsum core layer. In this regard, in one embodiment, the first gypsum core layer may have the same composition as the second gypsum core layer except that the second gypsum core layer may be formed using a foaming agent and/or foam or a greater amount of a foaming agent and/or foam.

In one embodiment, the gypsum core may also include a third gypsum core layer. The third gypsum core layer may be provided between the second gypsum core layer and a second facing material. Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of a foaming agent and/or foam or with a reduced amount of a foaming agent and/or foam, which may be utilized in forming the second gypsum core layer. In this regard, in one embodiment, the third gypsum core layer may have the same composition as the second gypsum core layer except that the second gypsum core layer may be formed using a foaming agent and/or foam or a greater amount of a foaming agent and/or foam.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include a foaming agent and/or foam or more foaming agent and/or foam than the first gypsum slurry. In this regard, in one embodiment, the first gypsum slurry may not include a foaming agent and/or foam. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include a foaming agent and/or foam and/or foam or more foaming agent and/or foam than the third gypsum slurry. In this regard, in one embodiment, the third gypsum slurry may not include a foaming agent and/or foam. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

Various gypsum core layers (e.g., first gypsum core layer, second gypsum core layer, third gypsum core layer) may sometimes be a particularly suitable location for one or more carbon sequestration additives. When included in a gypsum core layer, one or more carbon sequestration additives may enhance the properties of the gypsum panel. For instance, the one or more carbon sequestration additives may enhance the carbon sequestration properties of the gypsum panel.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

As indicated herein, the gypsum core can include one or more carbon sequestration additives. In this regard, in one embodiment, the first gypsum core layer may include one or more of the carbon sequestration additives disclosed herein. In another embodiment, the second gypsum core layer may include one or more of the carbon sequestration additives as disclosed herein. In a further embodiment, the third gypsum core layer may include one or more of the carbon sequestration additives as disclosed herein. In an even further embodiment, the first gypsum core layer and the second gypsum core layer may include one or more of the carbon sequestration additives as disclosed herein. In another further embodiment, the first gypsum core layer, the second gypsum core layer, and the third gypsum core layer may include one or more of the carbon sequestration additives as disclosed herein.

Regardless of the above, one or more carbon sequestration additives may be present in any combination of gypsum core layers. However, in one embodiment, it should be understood that one or two of the aforementioned gypsum core layers may not include a carbon sequestration additive. In one aspect, one or more gypsum core layers may comprise the same carbon sequestration additive. Further, in one aspect, the one or more gypsum core layers may comprise different carbon sequestration additives. The different carbon sequestration additives of the one or more gypsum core layers may be chosen such that it is advantageous to have a particular carbon sequestration additive in one gypsum core layer and a different carbon sequestration additive in another, different gypsum core layer.

The gypsum panel disclosed herein may have many applications. For instance, the gypsum panel may be used as a standalone panel in construction for the preparation of walls, ceilings, floors, etc. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling.

The specific surface area of the gypsum core is not necessarily limited and may be from about 0.25 m²/g to about 15 m²/g. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more, such as 5 m²/g or more, such as 6 m²/g or more, such as 8 m²/g or more, such as 10 m²/g or more. The specific surface area of the gypsum core may be 15 m²/g or less, such as 10 m²/g or less, such as 8 m²/g or less, such as 6 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less. Notably, carbon dioxide may more readily come into contact with the one or more carbon sequestration additives as the specific surface area of the gypsum core increases.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present invention is not necessarily limited by the aforementioned thicknesses.

In addition, the panel weight of the gypsum panel is not necessarily limited. For instance, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight such as after the panel leaves the heating or drying device (e.g., kiln).

In addition, the gypsum panel may have a density of about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as tested according to ASTM C1396-17. The nail pull resistance may be about 400 lb_{f} or less, such as about 300 lb_{f} or less, such as about 200 lb_{f} or less, such as about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C1396-17. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396-17. The gypsum panel may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f}, such as at least about 24 lb_{f}, such as at least about 28 lb_{f}, such as at least about 30 lb_{f}, such as at least about 33 lb_{f} as tested according to ASTM C1396-17 and ASTM C473-19. The gypsum panel may have an edge hardness of about 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17 and ASTM C473-19. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, as previously disclosed, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%±3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A gypsum panel comprising a gypsum core and a first facing material and a second facing material sandwiching the gypsum core, wherein the gypsum core comprises gypsum and one or more carbon sequestration additives comprising a silicate, one or more metal hydroxides, or a combination thereof.

2. The gypsum panel of claim 1, wherein the silicate is a silicate mineral.

3. The gypsum panel of claim 2, wherein the silicate mineral is a solid solution series mineral.

4. The gypsum panel of claim 3, wherein the silicate mineral is olivine sand.

5. The gypsum panel of claim 4, wherein the olivine sand comprises one or more intermediate compositions of an olivine solid solution series and/or one or more endmembers from an olivine solid solution series.

6. The gypsum panel of claim 4, wherein the olivine sand comprises one or more intermediate compositions of the forsterite and fayalite olivine solid solution series and/or one or more endmembers of the forsterite and fayalite olivine solid solution series.

7. The gypsum panel of claim 2, wherein the silicate mineral is a nesosilicate.

8. The gypsum panel of claim 7, wherein the nesosilicate is olivine.

9. The gypsum panel of claim 2, wherein the silicate mineral reacts with carbon dioxide in an exothermic reaction.

10. The gypsum panel of claim 2, wherein the silicate mineral sequesters carbon dioxide under atmospheric conditions.

11. The gypsum panel of claim 2, wherein the silicate mineral, the one or more metal hydroxides, or both react with carbon dioxide to form a metal carbonate.

12. The gypsum panel of claim 1, wherein the one or more metal hydroxides comprise one or more alkaline-earth metal hydroxides.

13. The gypsum panel of claim 12, wherein the one or more alkaline-earth metal hydroxides are calcium hydroxide, magnesium hydroxide, or both.

14. The gypsum panel of claim 1, wherein at least one of the one or more carbon sequestration additives comprises two metal hydroxides.

15. The gypsum panel of claim 14, wherein at least one of the one or more carbon sequestration additives comprising two metal hydroxides is hydrated dolomitic lime.

16. The gypsum panel of claim 1, wherein the gypsum panel actively sequesters carbon dioxide for a period of time of one month or more.

17. The gypsum panel of claim 1, wherein the gypsum panel actively sequesters carbon dioxide for a period of time of one year or more.

18. The gypsum panel of claim 1, wherein the one or more carbon sequestration additives physically sequester carbon from the atmosphere.

19. The gypsum panel of claim 1, wherein the one or more carbon sequestration additives chemically sequester carbon from the atmosphere.

20. The gypsum panel of claim 1, wherein the one or more carbon sequestration additives are present in the gypsum core in an amount from about 0.01% to about 20% based on the weight of gypsum in the gypsum core.

21. The gypsum panel of claim 1, wherein a first gypsum core layer, a second gypsum core layer, a third gypsum core layer, or a combination thereof has an average void size from about 90 microns to about 800 microns.

22. The gypsum panel of claim 1, wherein the one or more carbon sequestration additives comprise slaked lime, hydrated dolomitic lime, or a combination thereof.

23. The gypsum panel of claim 1, wherein gypsum panel has a sequestration efficiency of about 1% to about 100%.

24. The gypsum panel of claim 1, wherein the gypsum core comprises a first gypsum core layer and a second gypsum core layer, the first gypsum core layer between the second gypsum core layer and the first facing material and having a density greater than the second gypsum core layer, the one or more carbon sequestration additives being present in the first gypsum core layer, the second gypsum core layer or both.

25. A method for making the gypsum panel of claim 1 comprising:
providing a first facing material;
depositing a gypsum slurry comprising stucco, water, and one or more carbon sequestration additives onto the first facing material, wherein the one or more carbon sequestration additives comprise a silicate, one or more metal hydroxides, or a combination thereof;
providing a second facing material on the gypsum slurry; and
allowing the stucco to convert to calcium sulfate dihydrate.

26. A gypsum panel comprising a gypsum core and a first facing material and a second facing material sandwiching the gypsum core, wherein the gypsum core comprises gypsum and one or more carbon sequestration additives comprising activated coke, a volcanic glass, a volcanic rock, pyrolyzed biomass, an attapulgite clay, an aluminosilicate, a metal organic framework, a coordination polymer, an amine, an amide, a germanate, a stannate, an aluminophosphate, a covalent organic framework, an ionic liquid, an ionic exchange resin, a mesoporous silica, a functionalized mesoporous silica, a functionalized organic resin, or a combination thereof.
